(19) United States
(12) Patent Application Publication
(10) Pub. No.: US 2005/0081329 A1
(43) Pub. Date: Apr. 21, 2005

(54) Office chair castor

(76) Inventor: Po-Chuan Tsai, Tainan Hsien (TW)

Correspondence Address: Po-Chuan Tsai, P.O. Box 90, Tainan City, 704, TW

(21) Appl. No.: 10/685,470

(22) Filed: Oct. 16, 2003

(51) Int. Cl. B60B 33/00

(52) U.S. Cl. 16/18 R

(57) ABSTRACT

An office chair castor includes a base, two castor bodies, two beads bases, and two set of beads. The beads of the two sets of beads positioned in portion grooves of the two beads bases are also rotatably positioned in both the grooves of the two projecting annular walls of the base and the grooves of the two castor bodies, permitting the mutual contact dimension of the base and the two castor bodies become small to cause small friction, which may produce little noise and may let the castor bodies not to be stuck but rotate smoothly.

### BACKGROUND OF THE INVENTION

1. Field of the Invention

This invention relates to an office chair castor, particularly to one having two sets of beads positioned in both the grooves of two projecting annular walls of a base and in the grooves of two castor bodies, permitting the castor bodies rotate smoothly relative to the base. In rotating, the two castor bodies may produce little noise because of small contact dimension to cause small friction between the castor bodies and the base, and the castor bodies may never be stuck thanks to rotation of the beads.

2. Description of the Prior Art

A conventional office chair castor shown in FIG. 1 includes a base 10, a pivot hole 11 formed vertically in the base 10, a shaft sleeve 12 with a center shaft hole 13 formed inside the base 10, a shaft 14 extending through the shaft hole 13 of the shaft sleeve 12 to both sides of the shaft sleeve 12 and having an annular groove 15 respectively in two ends, two castor bodies 16 combined respectively with two sides of the shaft sleeve 12 and having a shaft sleeve 17 in its interior. The shaft sleeve 17 has a center shaft hole 18, a projecting edge 19 formed in the shaft hole 18. The two ends of the shaft 14 are positioned in the shaft hole 18 of the castor bodies 16, and the projecting edge 19 fitting in the annular grooves 15 to fix firmly the castor bodies 16 in the base 10.

However, the castor bodies 16 of the conventional office chair castor are combined in the base 10 by means of the shaft 14 extending in the shaft hole 13 of the base 10. As the shaft 14 and the shaft hole 13 contact with each other with a large dimension, noise may substantially be produced by friction of the shaft 14 against the shaft hole 13 of the base 10 during rolling of the castor bodies 16. Moreover, the large contact dimension easily causes the shaft 14 stuck against the base 10, resulting in unsmooth rolling of the castor bodies 16.

### SUMMARY OF THE INVENTION

The purpose of the invention is to offer an office chair castor rolling stably and smoothly, producing little noise or being stuck.

One feature of the invention is a base with a pivot hole, a center hole. And a projecting annular wall respectively at two sides of the base, two castor bodies combined respectively with the two sides of the base and having a center hole.

Another feature of the invention is two sets of beads rotatably positioned in both the grooves of the two projecting annular walls of the base and the grooves of the two castor bodies by means of two beads bases positioned between the two castor bodies and the two projecting annular walls of the base. Then the castor bodies can rotate freely without being stuck against the base thanks to the beads.

### BRIEF DESCRIPTION OF DRAWINGS

This invention will be better understood by referring to the accompanying drawings, wherein:

FIG. 1 is an exploded perspective view of a conventional office chair castor;

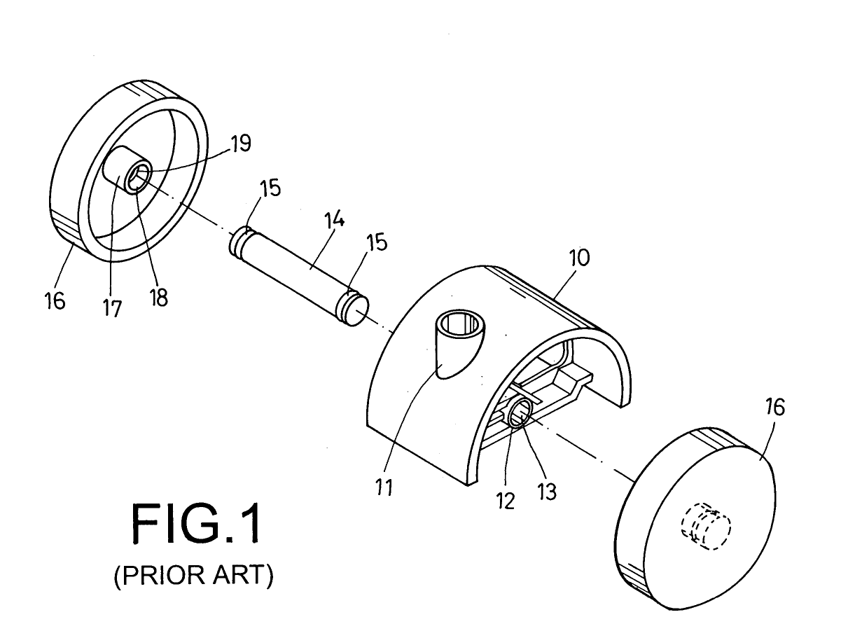

FIG. 2 is an exploded perspective view of an office chair castor in the present invention;

FIG. 3 is a perspective view of the office chair castor in the present invention; and,

FIG. 4 is a cross-sectional view of the office chair castor in the present invention.

### DETAILED DESCRIPTION OF THE PREFERRED EMBODIMENT

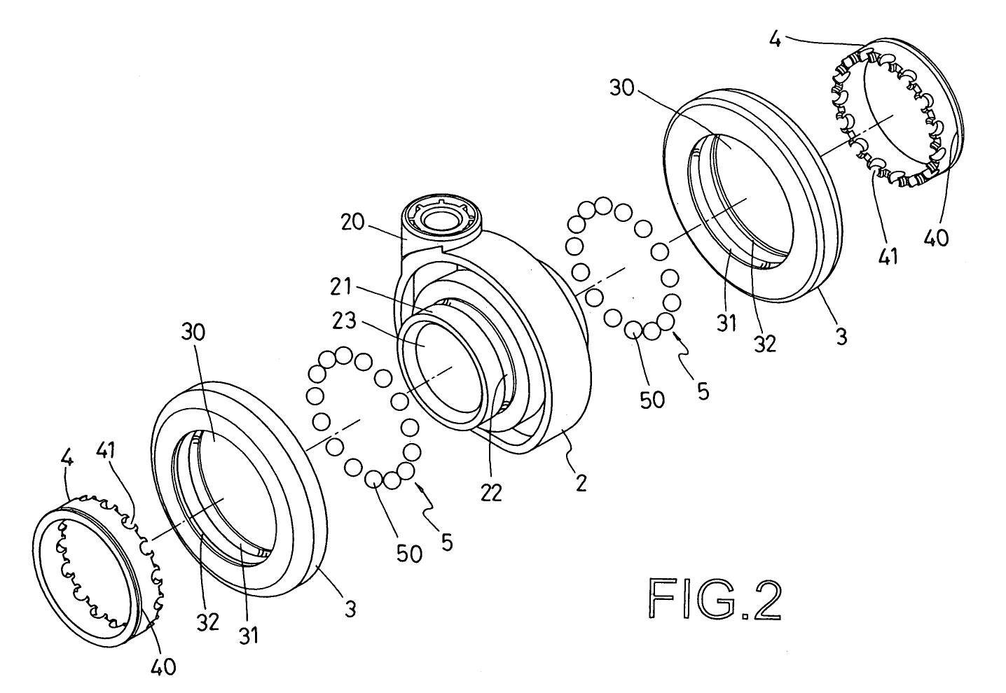

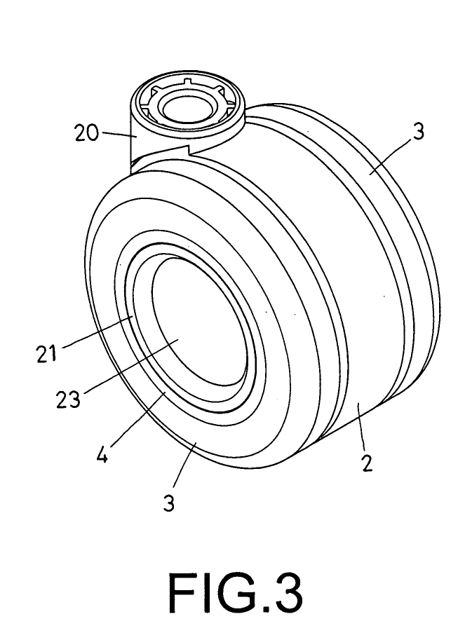

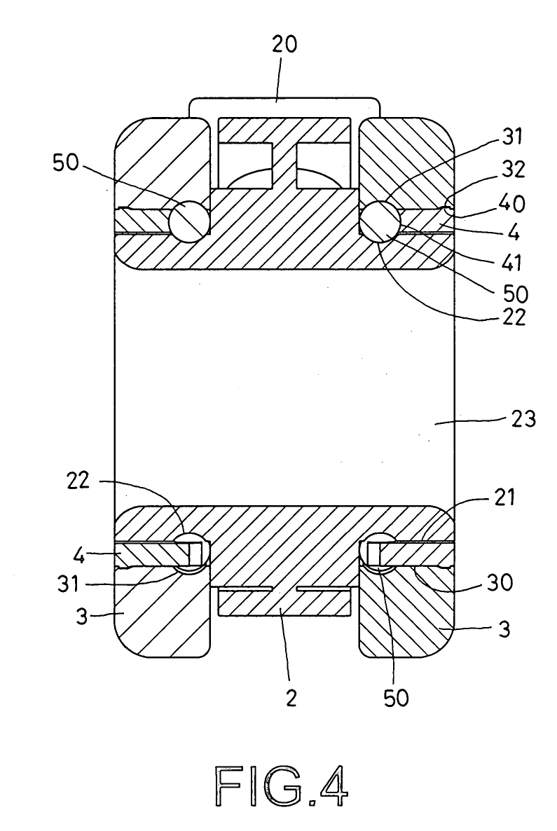

A preferred embodiment of an office chair castor in the present invention, as shown in FIGS. 2, 3 and 4, includes a base 2, two castor bodies 3, two beads bases 4 and two sets of beads 5 as main components combined together.

The base 2 has a vertical pivot hole 20, a center hole 23, and a projecting annular wall 21 respectively formed in two sides. Each projecting annular wall 21 has an annular groove 22 in an inner surface.

The two castor bodies 3 are respectively combined with the two projecting annular walls 21 of the base 2, having a center hole 30, and an annular groove 31 and an insert groove 32 formed in the inner wall defining the center hole 30.

The two beads bases 4 are respectively combined in the center hole 30 of each castor body 3, having respectively a flange 40 at an outer end and a plurality of position grooves 41 formed in an inner annular edge.

The two sets of beads 5 respectively consists of plural beads 50 positioned in both the grooves of the two projecting annular walls 212 of the base and the position grooves 41 of each beads base 4.

In assembling, referring to FIGS. 2, 3 and 4, firstly, place the two beads bases 4 in the center holes 30 of the two castor bodies 3, with the flanges 40 of the bead bases 4 fitting in the insert grooves 32 of the center holes of the two castor bodies 3. Then the beads 50 of the two sets of beads 5 are respectively placed in the position grooves 41 of the beads bases 4. After that, the castor bodies 3 are respectively combined with the two sides of the base 2, with the beads 50 kept in the grooves 22 and 31 of both the base 2 and the castor bodies 3, stabilizing the castor bodies 3 with the base, finishing the assembly of the office chair castor in the present invention.

In case of using, the beads 50 of the two sets of beads 5 rotate in both the grooves 22 of the projecting annular walls 21 of the base 2 and the grooves 31 of the center hole 30 of the castor bodies 3, permitting the castor bodies 3 roll relative to the base 2. During rolling of the castor bodies 3, little noise may be produces, thanks to the small dimension of mutual contact of the castor bodies 3 with the base 2, and subsequent small dimension of their friction. In addition, rotation of the beads helps to get rid of the condition of the castor bodies 3 being stuck, permitting the castor bodies roll with smoothness.

While the preferred embodiment of the invention has been described above, it will be recognized and understood that various modifications may be made therein and the appended claims are intended to cover all such modifications that may fall within the spirit and scope of the invention.

1. An office chair castor comprising:
a base provided with a vertical pivot hole, a center hole, and a projecting annular wall respectively formed at two sides, each said projecting annular wall having an annular groove in an inner surface;
two castor bodies respectively combined with the projecting annular walls of said base, each said castor body having a center hole, an annular groove and an insert groove formed in an inner surface of each said body;
two beads bases respectively combined in the center hole of each said castor body, having a flange formed in an outer end and a plurality of position grooves in an inner end;
two sets of beads respectively having a plurality of beads positioned in the position grooves of each said beads base; and,
said beads of said two sets of beads rotatably positioned in both the grooves of said two projecting annular walls of said base and the annular grooves of said center hole of said two castor bodies, said castor bodies possible to rotate relative to said base with their mutual contact dimension being small to cause small mutual friction so that noises may be prevented from happening, and castor bodies may not be stuck owing to rotation of said beads, rotatable smoothly.
